(19) United States
(12) Patent Application Publication
(10) Pub. No.: US 2010/0176735 A1
(43) Pub. Date: Jul. 15, 2010

(54) LED light string assembly with constant current circuit

(76) Inventor: Chen-Sheng Yang, Kaohsiung (TW)

Correspondence Address: COOPER & DUNHAM, LLP, 30 Rockefeller Plaza, 20th Floor, NEW YORK, NY, 10112, US

(21) Appl. No.: 12/321,029

(22) Filed: Jan. 15, 2009

(51) Int. Cl. F21S 4/00

(52) U.S. Cl. 315/185 S

(57) ABSTRACT

An LED light string assembly has a plug, an extension socket, a light string connected between the plug and the extension socket, and at least one constant current circuit connected to the light string. The constant current circuit has a first input capacitor, a second input capacitor, a first diode, a second diode and a filter capacitor. The first input capacitor is connected in series to the second input capacitor between a first AC terminal and the cathode of the first diode. The second diode is connected between the first diode and the second AC terminal. The filter capacitor is connected between the cathode of the first diode and the second AC terminal.

### BACKGROUND OF THE INVENTION

1. Field of the Invention

The present invention relates to a LED light string assembly, and more particularly to a LED light string assembly with a constant current circuit.

2. Description of Related Art

With reference to FIGS. 5 to 7, a conventional LED light string comprises a plug (50), an extension socket (52), multiple light emitting diodes (LEDs) (54) connected between the plug (50) and the extension socket (52) and two resistors (56). The plug (50) has two conductive contacts (501) for electrically connecting an AC voltage (60) and two first diodes (502). The extension socket (52) has two slots (521) for correspondingly connecting a plug of a subsequent LED light string. The extension socket (52) has two second diodes (522).

The two first diodes (502) in the plug and the second diodes (522) form a bridge rectifier to convert the AC voltage to a DC voltage supplied to drive the LEDs (54). To construct a relative long light string, multiple foregoing LED light strings should be connected sequentially by fitting the conductive contacts (501) of a next LED light string into the two slots (521) of a previous LED light string.

The two resistors (56) are respectively mounted in the plug (50) and the socket (52) and are connected to the LEDs (54) in series.

However, when any one of the light emitting diodes (LEDs) (54) is damaged, the damaged LED (54) become a short circuit. Because of the short circuit, the current flowing through the multiple light emitting diodes (LEDs) (54) increases. According to the equation P=I×R, the increasing of the current (I) leads to a higher power consumption (P) and temperature. The high temperature eventually causes a breakdown of the two resistors (56).

To overcome the shortcomings, the present invention provides an LED light string assembly with a constant current circuit to mitigate or obviate the aforementioned problems.

### SUMMARY OF THE INVENTION

The main objective of the present invention is to provide an LED light string assembly having a constant current circuit to ensure lighting elements of the light string assembly being driven by a fixed current even though any one of the lighting elements becomes short circuit.

To accomplish the objective, the LED light string assembly has a plug, an extension socket, a light string connected between the plug and the extension socket, and at least one constant current circuit connected to the light string. The constant current circuit has a first input capacitor, a second input capacitor, a first diode, a second diode and a filter capacitor. The first input capacitor is connected in series to the second input capacitor between a first AC terminal and the cathode of the first diode. The second diode is connected between the first diode and the second AC terminal. The filter capacitor is connected between the cathode of the first diode and the second AC terminal.

Other objectives, advantages and novel features of the invention will become more apparent from the following detailed description when taken in conjunction with the accompanying drawings.

### BRIEF DESCRIPTION OF THE DRAWINGS

FIG. 1 is a circuit diagram of a constant current circuit of an LED light string assembly in accordance with the present invention;

FIG. 2 is a schematic view of the constant current circuit being mounted in a plug of the LED light string assembly in accordance with the present invention;

FIG. 3 is a schematic view of the constant current circuit being mounted in a socket of the LED light string assembly in accordance with the present invention;

FIG. 4 is a circuit diagram of a constant current circuit of an LED light string assembly in accordance with a second embodiment of the present invention;

FIG. 5 is a perspective view of a conventional LED light string with a front plug and a rear extension socket;

FIG. 6 is a cross sectional view in partial of the conventional LED light string of FIG. 5; and

FIG. 7 is an equivalent circuit of the conventional LED light string of FIG. 5.

### DETAILED DESCRIPTION OF THE PREFERRED EMBODIMENT

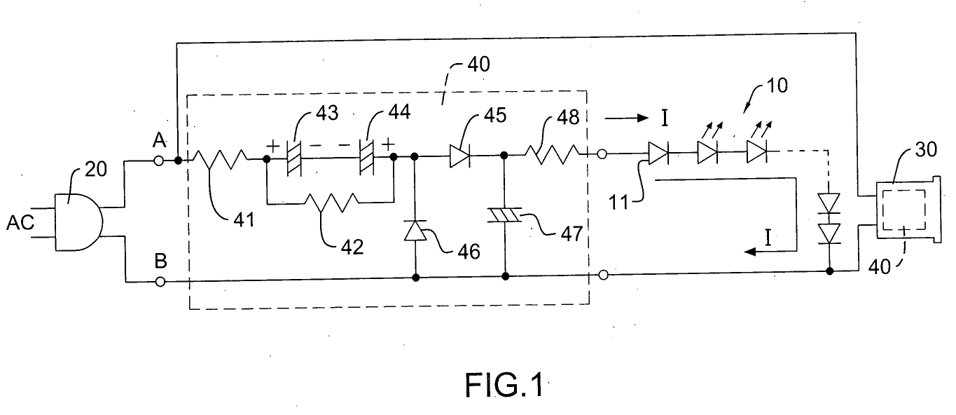

With reference to FIGS. 1 to 3, a LED light string assembly in accordance with the present invention comprises a light string (10), a plug (20), an extension socket (30) and a constant current circuit (40) mounted in the plug (20) or in the both in the plug (20) and the socket (30).

The light string (10) comprises multiple LED lights (11) connected in series.

The plug (20) has a chamber and two contacts (21) protruding from the chamber for electrically receiving an AC voltage.

The extension socket (30) is connected to the other end of the light string (10) and has a chamber with two slots (31) for further connecting to another subsequent light string.

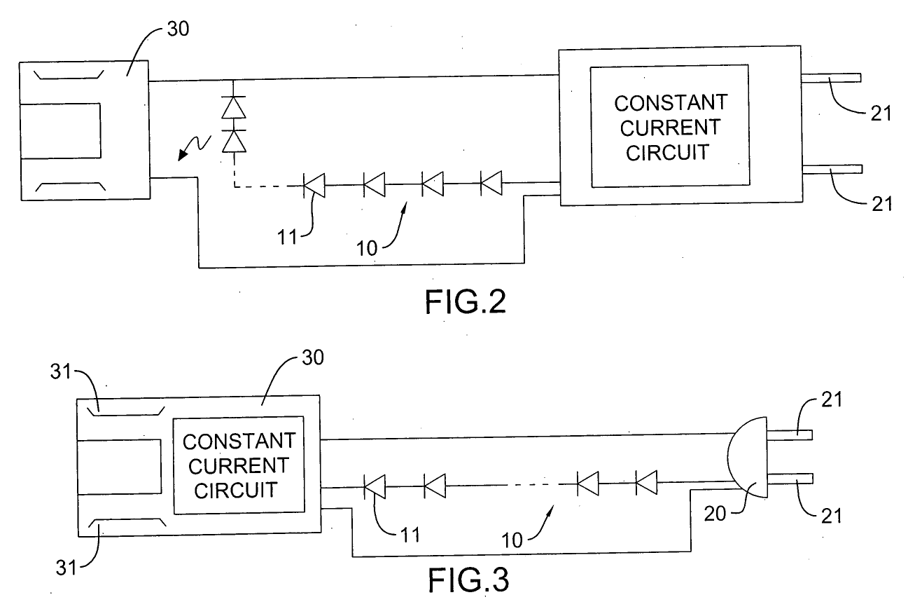

The constant current circuit (40) comprises an optional first input resistor (41), an optional second input resistor (42), a first input capacitor (43), a second input capacitor (44), a first diode (45), a second diode (46), a filter capacitor (47) and an optional output resistor (48). The constant current circuit (40) may be implemented in the plug (20) as shown in FIG. 2 to drive a single light string (10), or be implemented in both the plug (20) and the extension socket (30) to driver a first light string and other subsequent light string (10) coupled to the extension socket (30).

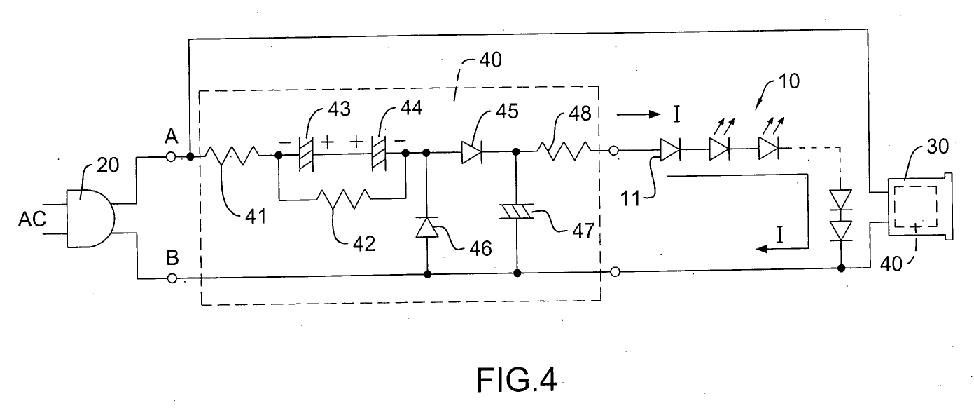

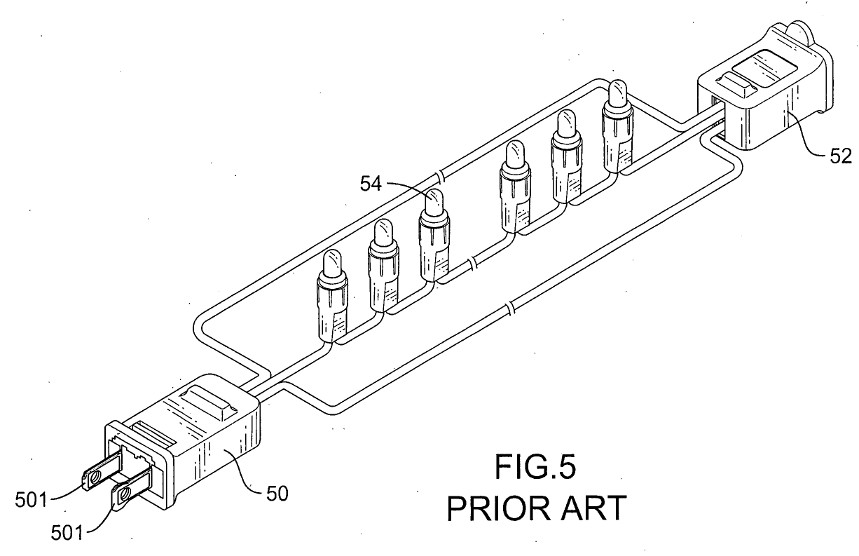

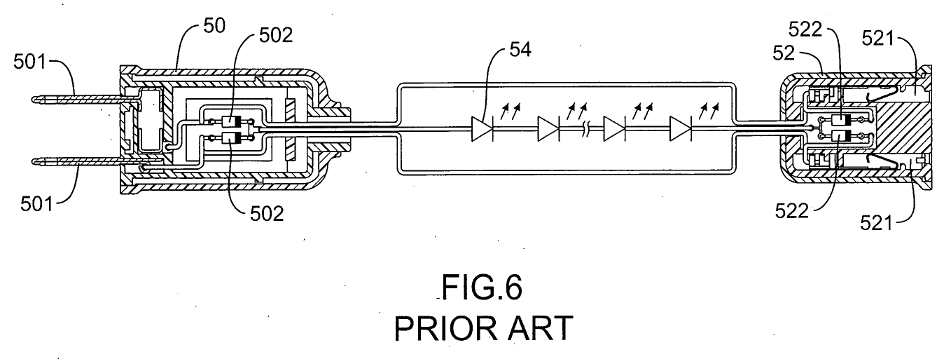

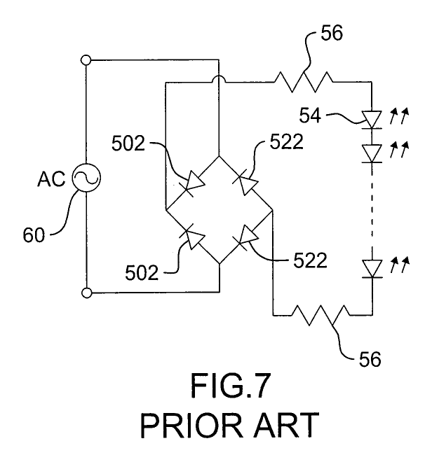

The first input capacitor (43) and the second input capacitor (44) respectively has a terminal connected together, the two terminals having the same polarity as shown in FIGS. 1 and 4, i.e. positive connected to positive or negative connected to negative. The first input capacitor (43) further connects to a first AC terminal (A) through the first optional input resistor (41) that is used as a current limiting resistor. The second input capacitor (44) further connects to the anode of the first diode (45).

The optional second input resistor (42) is connected in parallel to the first input capacitor (43) and the second input capacitor (44).

The second diode (46) has a cathode and an anode being respectively connected to the anode of the first diode (45) and the second AC terminal (B).

The filter capacitor (47) is connected between the cathode of the first diode (45) and the second AC terminal (B).

The output resistor (48) is connected to the cathode of the first diode (45) and the light string (10). For example, the output resistor (48) is connected to an anode of the first LED light (11) of the light string (10).

The constant current circuit (40) converts the AC voltage to a DC voltage. The DC voltage drives the light string (10) to emit light. According to the equation

$${X}_{C} = \frac{1}{2 π f \cdot C} ,$$

the two input capacitors (43)(44) will provide a constant capacitive reactance Xc as long as the AC voltage has a constant frequency. The constant capacitive reactance Xc leads to a constant current flowing through the light string (10) even though any one of the LED lights (11) becomes failure. In other words, the constant current circuit (40) ensures the light string (10) is driven by a constant current to achieve high operating safety.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light emitting diode (LED) light string assembly comprising:
a plug receiving an AC voltage being output from a first AC terminal and a second AC terminal;
an extension socket having two slots;
a light string being connected between the plug and the extension socket, and comprising multiple LED lights connected in series; and
at least one constant current circuit electronically connected to the light string, converting the AC power to DC power for driving the light string, and comprising:
a first input capacitor having a terminal connected to a terminal of the second input capacitor to form a series connection, the first input capacitor being connected to the first AC terminal, wherein the two terminals of the first input capacitor and the second input capacitor being connected together have the same polarity;
a first diode having an anode being connected to the second input capacitor, and having a cathode coupled to the light string;
a second diode having a cathode and an anode being respectively connected to the anode of the first diode and the second AC terminal;
a filter capacitor connected between the cathode of the first diode and the second AC terminal.

2. The LED light string assembly as claimed in claim 1 further comprising:
a first input resistor being connected between the first AC terminal and the first input capacitor;
a second input resistor being connected in parallel to the first input capacitor and the second input capacitor; and
an output resistor being connected between the of the cathode of the first diode and the light string.

3. The LED light string assembly as claimed in claim 1, wherein the at least one constant current circuit is implemented in the plug.

4. The LED light string assembly as claimed in claim 2, wherein the at least one constant current circuit is implemented in the plug.

5. The LED light string assembly as claimed in claim 1, wherein the at least one constant current circuit has two constant current circuit being respective implemented in the plug and the extension socket.

6. The LED light string assembly as claimed in claim 2, wherein the at least one constant current circuit has two constant current circuit being respective implemented in the plug and the extension socket.
